(19) United States
(12) Patent Application Publication
(10) Pub. No.: US 2022/0155731 A1
(43) Pub. Date: May 19, 2022

(54) MULTI-FUNCTION CLOCK

(71) Applicant: LittleHippo, Inc., Manhasset, NY (US)

(72) Inventors: Stephanie LAI, Manhasset, NY (US); Dennis LIU, Manhasset, NY (US)

(21) Appl. No.: 17/526,543

(22) Filed: Nov. 15, 2021

Related U.S. Application Data
(60) Provisional application No. 63/113,542, filed on Nov. 13, 2020.

(51) Int. Cl. G04G 13/02; G04G 9/02; G04B 25/00; H04W 4/80; G04G 21/04; G04G 9/00

(52) U.S. Cl. CPC G04G 13/021; G04G 9/027; G04G 9/0064; H04W 4/80; G04G 21/04; G04B 25/005

(57) ABSTRACT

A multi-function clock is provided in which a clock face is configured to exhibit a first mode in association with a first clock function and a second mode in association with a second clock function. A first illumination feature is then configured to operate in association with at least the first mode and a second illumination feature is configured to operate in association with at least the second mode.

### CROSS-REFERENCE TO RELATED APPLICATION

This application claims the benefit of U.S. Provisional Patent Application No. 63/113,542 filed Nov. 13, 2020, the entirety of which is hereby incorporated by reference herein.

### FIELD

The present disclosure generally relates to a multi-function clock.

### BACKGROUND

Conventionally, a multi-function clock is understood. Such a multi-function clock functions as a sleep trainer, an alarm clock, a sleep sounds machine, a night light and/or a nap timer.

### SUMMARY

A multi-function clock is provided in which a clock face is configured to exhibit a first mode in association with a first clock function and a second mode in association with a second clock function. A first illumination feature is then configured to operate in association with at least the first mode and a second illumination feature is configured to operate in association with at least the second mode.

In some embodiments, each of the first illumination feature and the second illumination feature is configured to operate independent of the other.

In some embodiments, each of the clock face, the first illumination feature and the second illumination feature is configured to operate independent of each other.

In some embodiments, the second illumination feature is further configured to operate in association with the first mode and when each of the first illumination feature and the second illumination feature operates in association with the first mode, the first illumination feature exhibits a first behavior in association with the first mode and the second illumination feature exhibits a second behavior in association with the first mode.

In some embodiments, the first illumination feature is further configured to change an appearance as an indication of time lapse information. In some such embodiments, the first illumination feature is configured to operate as a countdown timer or a count up timer in consecutive first and second routines. In the first routine, the first illumination feature is configured to change from a first color to a second color and in the second routine the first illumination feature is further configured to change from the second color to a third color.

In some embodiments, the first mode is a sleep trainer mode and the second mode is a mode other than a sleep trainer mode. In some such embodiments, the second mode is in association with a timed activity featuring a countdown illumination.

In some embodiments, the first illumination feature and the second illumination feature have different shapes. In some such embodiments, in a front view, the first illumination feature at least partially surrounds the clock face, and in the front view, the second illumination feature at least partially surrounds the clock face.

In some such embodiments, the first illumination feature is in the shape of a ring, and the ring is configured to illuminate partially or completely. In one of the first and second modes, the ring counts down time or counts up time, and the ring and the second illumination feature are configured to exhibit independent behaviors.

In some such embodiments, the first illumination feature is in the shape of a ring, and the ring comprises a plurality of discrete segments that illuminate independently, and when the ring partially illuminates, one or more of the discrete segments illuminate and the remaining of the discrete segments do not illuminate.

In some such embodiments, the second illumination feature at least partially surrounds the first illumination feature. In some such embodiments, the second illumination feature is configured to change appearance over time.

In some embodiments, the clock face is configured to exhibit at least one of the time or an image of an activity that is timed.

In some embodiments, at least one of an activity of the clock face, an activity of the first illumination feature, and an activity of the second illumination feature is configured to operate in response to the multi-function clock being tapped.

In some embodiments, an appearance of the second illumination feature is configured to change based on a preset wake-up time.

A method may also be provided, the method comprising causing a user device to exhibit at least one setting screen for a first mode in association with a first clock function and a second mode in association with a second clock function. The method then receives, from the user device, setting contents of the first mode and the second mode and transmits, to a multi-function clock, the received setting contents.

Such setting contents t configure a clock face of the multi-function clock to exhibit the first mode and the second mode, a first illumination feature of the multi-function clock to operate in association with at least the first mode, and a second illumination feature of the multi-function clock to operate in association with at least the second mode.

Also provided is a server for implementing such a method, the server comprising a memory that stores a plurality of instructions, and processor circuitry that couples to the memory and is configured to execute the instructions.

The instructions cause a user device to exhibit at least one setting screen for a first mode in association with a first clock function and a second mode in association with a second clock function, receive, from the user device, setting contents of the first mode and the second mode, and transmit, to a multi-function clock, the received setting contents.

Such received setting contents configure a clock face of the multi-function clock to exhibit the first mode and the second mode, a first illumination feature of the multi-function clock to operate in association with at least the first mode, and a second illumination feature of the multi-function clock to operate in association with at least the second mode.

### BRIEF DESCRIPTION OF THE DRAWINGS

FIG. 1 is a schematic diagram of a system according to one embodiment of the present disclosure.

FIGS. 2A and 2B illustrate multi-function clocks according to one embodiment of the present disclosure.

FIGS. 3A-C illustrate user devices according to one embodiment of the present disclosure.

FIG. 4 illustrates a flowchart of a method according to one embodiment of the present disclosure.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

The present embodiment may be directed to a multi-function clock. The clock may include a clock face, a first illumination feature, and a second illumination feature. The clock face may be configured to exhibit a first mode in association with a first clock function and a second mode in association with a second clock function. The first illumination feature may be configured to operate in association with at least the first mode. The second illumination feature may be configured to operate in association with at least the second mode. Other modes and illumination features are contemplated.

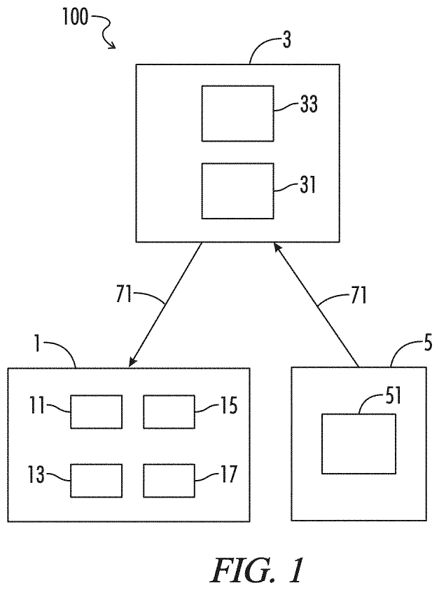

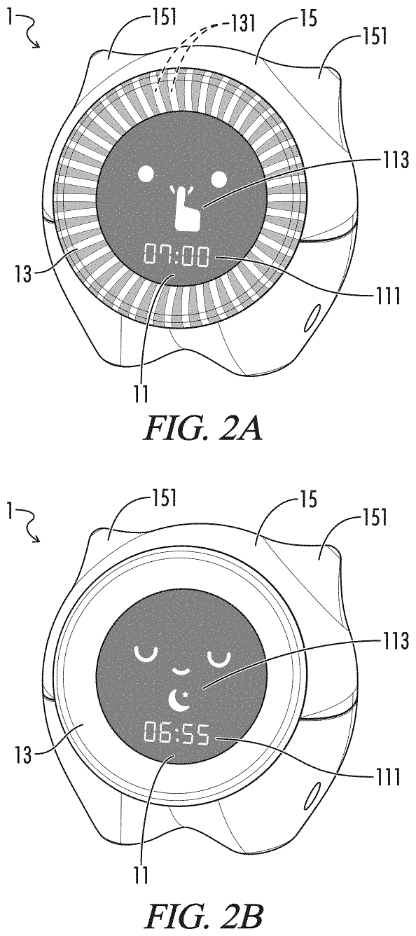

As shown in FIG. 1, one embodiment of a multi-function clock system 100 may be provided. The multi-function clock system 100 may include a multi-function clock 1, a server 3, and a user device 5. With reference to FIGS. 2A and 2B, the multi-function clock 1 may operate to implement a plurality of clock functions. The clock functions may include, but are not limited to, various functions, such as a sleep trainer function, a tooth brushing training function, a timer function, an alarm clock function, and a night light function. Other functions are contemplated.

As shown in the embodiment of FIGS. 2A and 2B, the multi-function clock 1 may include a clock face 11, a first illumination feature 13, and a second illumination feature 15. The clock face 11 may be configured to exhibit a plurality of modes that are respectively in association with the plurality of clock functions. For example, the clock face 11 may be configured to exhibit a first mode in association with a first clock function and a second mode in association with a second clock function. In one example, the first mode may be a sleep trainer mode and the second mode may be a mode other than a sleep trainer mode. The second mode may be a timer mode, which is in association with a timed activity featuring a countdown illumination. The clock face 11 may be configured to exhibit at least one of the time 111 and an image or icon 113 representing an activity that is timed. The clock face 11 may exhibit different facial expression/animations. For example, the clock face 11 of FIG. 2A exhibits a smiling face, and the clock face 11 of FIG. 2B exhibits a sleeping face.

In some embodiments, the clock face 11 may be divided into discrete segments showing the time 111 and the image or icon 113. As shown, this may allow the time 111 to be shown in the same manner and/or location in a variety of modes, where distinct modes are represented by distinct images or icons 113.

As shown in the embodiment of FIGS. 2A and 2B, in a front view, the first illumination feature 13 may at least partially surround the clock face 11. In the illustrated embodiment, the first illumination feature 13 completely surrounds the clock face 11. The first illumination feature 13 may be in various shapes, and in the example shown, the first illumination feature 13 may be in the shape of a ring. The ring may be configured to illuminate partially or completely. In some embodiments, the first illumination feature 13 may be configured to change appearance (e.g., color and/or intensity) over time. For example, the first illumination feature 13 may be configured to change an appearance as an indication of time lapse information. In this example, the first illumination feature 13 functions as a count down or count up timer.

The ring of the first illumination feature 13 may include a plurality of discrete segments 131 that illuminate independently, thereby allowing the illumination feature to be partially illuminated. As shown in FIG. 2A, the segments 131 may be arranged along a circumferential direction of the ring. In one embodiment, the ring of the first illumination feature 13 may completely illuminated by illuminating each of the discrete segments at the beginning of a time period and then the illumination of the segments 131 of the first illumination feature 13 may be deactivated as time elapses. As such, when the ring of the first illumination feature 13 partially illuminates, one or more of the discrete segments 131 illuminate and remaining discrete segments 131 do not illuminate. In another embodiment, the first illumination feature 13 may operate in the opposite way where the segments 131 of the illumination feature 13 may be independently illuminated as time elapses.

In an alternative embodiment, the segments 131 of the first illumination feature 13 may be illuminated in a variety of colors, such that when counting down or up, instead of illuminating and deactivating individual segments, a color of such segment may be changed. As such, while the entire first illumination feature 13 may be lit in yellow initially, the discrete segments 131 may be sequentially changed to red, or green, in order to indicate a countdown or count up process. Further, the first illumination feature 13 may be able to provide sequential countdowns, while the illumination feature first transitions from a first color to a second color, and once the illumination feature is wholly lit in the second color, it can transition from the second color to a third color. Similarly, it may initially activate the illumination of the discrete segments 131 as part of a first part of a count up, or deactivate the illumination as a final part of a countdown.

As shown in FIGS. 2A and 2B, the second illumination feature 15 may be disposed at a location different from the location of the first illumination feature 13. The second illumination feature 15 may be different in shape from the first illumination feature 13. In the front view, the second illumination feature 15 may at least partially surround each of the clock face 11 and the first illumination feature 13. In the illustrated embodiment, in the front view, the second illumination feature 15 surrounds an upper half of each of the clock face 11 and the first illumination feature 13. The second illumination feature 15 may be configured to change appearance (e.g., color and/or intensity) over time. Alternatively, the second illumination feature 15 may be configured to illuminate in a single color.

As stated above, the first illumination feature 13 may be configured to operate in association with at least the first mode, and the second illumination feature 15 may be configured to operate in association with at least the second mode. In one example, each of the first illumination feature 13 and the second illumination feature 15 may be configured to operate independently of each other. In another example, each of the clock face 11, the first illumination feature 13, and the second illumination feature 15 may be configured to operate independently of each other.

In one embodiment, each of the first illumination feature 13 and the second illumination feature 15 may be configured to operate in association with the first mode, which may be a sleep trainer mode. In this example, the first illumination feature 13 may exhibit a first behavior (e.g., countdown to when it is time to get out of bed) in association with the first mode (e.g., sleep trainer mode) and the second illumination feature 15 may exhibit a second behavior (e.g., light-up) in association with the first mode (e.g., sleep trainer mode). In another example, an appearance of the second illumination feature 15 may be configured to change based on a preset wake-up time. In this example, the second illumination feature 15 may gradually brighten based on the preset wake-up time (which may be called a “sunrise feature”).

In another example, in one of the first and the second modes, which may be a tooth brushing mode, the ring of the first illumination feature 13 may count down time or count up time to make sure that tooth brushing happens for a certain period of time, and the ring and the second illumination feature 15 may be configured to exhibit independent behaviors.

Generally, in the embodiments shown, the image or icon 113 shown in the clock face 11 indicates a mode associated with the current behavior of the first illumination feature 13 and/or the second illumination feature. As such, the clock face 11 may display an icon 113 associated with quiet time, as shown in FIG. 2A, while the first illumination feature 13 counts down towards an end of quiet time. Similarly, the clockface 11 may illustrate an icon 113 associated with brushing teeth, and the first illumination feature 13 may count down an appropriate corresponding amount of time.

In some embodiments, the first illumination feature 13 may be configured to operate as a countdown timer or a count up timer in consecutive first and second routines. In the first routine, the first illumination feature 13 may be configured to change from a first color to second color, and in the second routine, the first illumination feature 13 may be configured to change from the second color to a third color. The first through third colors may be different from each other in color and/or intensity. As such, the color of the illumination feature 13 may disappear but may be replaced by a different color (such as the color associated with the next routine that comes after).

In some embodiments, at least one of an activity represented by the image or icon 113 of the clock face 11, an activity of the first illumination feature 13, and an activity of the second illumination feature 15 may be configured to operate in response to the multi-function clock 1 being tapped. The tapping may be detected by a sensor 17 (see FIG. 1) of the clock 1, and may be limited to specific portions of the clock. For example, the clock 1 may be in the shape of a stylized head, and a child may activate a specific feature or countdown if an ear 151 of the clock shape is tapped. Similarly, tapping a specific portion of the clock 1 may be used as an indication by a child that a particular task has been completed.

In some embodiments, the multi-function clock 1 may include a countdown reward button where if the setting is toggled on and the child completes a task early (and presses the button or taps a location on the clock 1), the clock face 11 may exhibit an animated face as the image or icon 131 rewarding the child. The clock 1 may include intelligent virtual assistant skills, such that the user can tell the clock 1 to turn the clock 1 on/off, etc. The clock 1 may include an intercom feature (i.e., two way where kid/parent can talk to each other from phone to the clock). The clock 1 may have a temperature sensor to detect the temperature in the room. Other features and/or benefits are contemplated.

With reference to FIG. 1, in one embodiment, the activities of the clock face 11, the first illumination feature 13, and the second illumination feature 15 may be controlled and/or customized by the user through the user device 5. The user device 5 may include a smartphone, a tablet computer, a laptop, a personal digital assistant (PDA), and the like. The user device 5 may include a display 51. The user device 5 may include software and/or hardware for controlling and/or customizing the activities of the clock 1. The software of the user device 5 may include a browser or other client software (including an “app”). The user device 5 may be connected with the server to communicate with the server 3. The user device 5 and the server 3 may be connected with each other wirelessly or wired. The server 3 may be connected with the multi-function clock 1 to communicate with the multi-function clock 1. The server and the clock may be connected with each other wirelessly or wired. Alternatively, user device 5 may communicate with the clock 1 directly (and not through a server) using Bluetooth® communication or the like or a local area network.

With reference to the embodiment of FIG. 1, the server 3 may be, but is not limited to, a cloud server. The server 3 may include a memory 31 and processor circuitry 33. The memory 31 may store a plurality of instructions. The processor circuitry 33 may be coupled to the memory 31 and may be configured to execute the instructions.

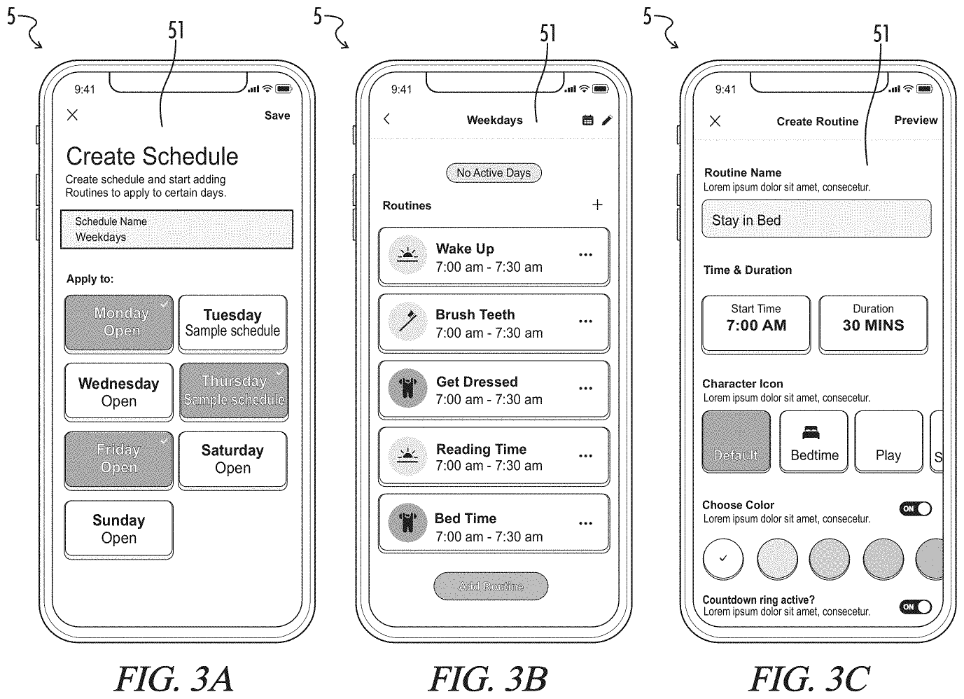

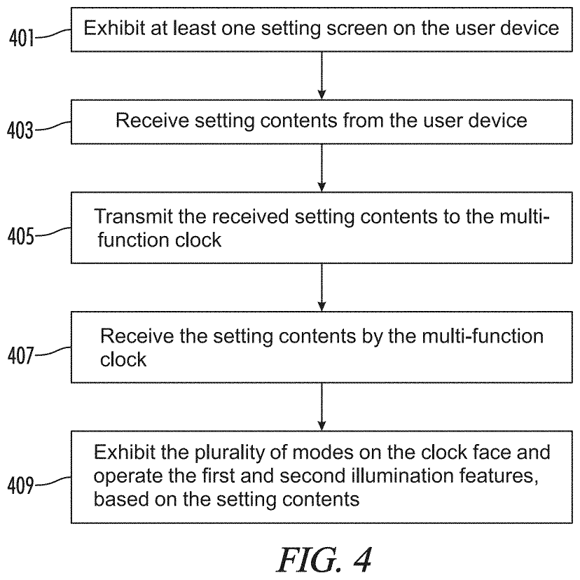

With reference to FIGS. 3A-3C, in order to control or customize the activities, the processor circuitry 33 of the sever 3 may cause the display 51 of the user device 5 to exhibit at least one setting screen (see 401 in FIG. 4). The at least one screen may include a screen for the first mode (e.g., sleep trainer mode shown as “Wake Up” in FIG. 3B) and a second mode (e.g., tooth brushing mode shown as “Brush Teeth” in FIG. 3B). Then, the user may input or choose the setting contents 71 of one or more routines to the user device 5, and then the server 3 may receive, from the user device 5, the setting contents 71 (see FIG. 1) of the first mode and the second mode (see 403 in FIG. 4).

The setting contents 71 may include setting contents for a name of a routine, a start time of a routine, a duration of a routine, the routine icon 113 that is exhibited on the clock face 11 (e.g., potty icon shows up for a potty routine), whether the image or icon 113 has a face animate on the clock face 11 during a routine (e.g., the clock face 11 brushing its teeth during a brush teeth routine), a color of the ring of the illumination feature 13, ability of the illumination feature 13 to have the light ring countdown to show the passage of time, night light (e.g., a single white color of the illumination feature 15), a sound (which can be, for example, a sleep sound, alarm sound, or even just music), and a completion reward (if this feature is toggled on, then if the child taps on ears 151 of the clock 1 before the routine is finished, the clock 1 rewards the child in some way such as the image or icon 113 being an excited face showing up on the clock face 11 or a “good job” sound, for example). In some embodiments, the parent can select from a list of pre-set routines and can also customize his/her own routines. In one example, for a sleep routine, the parent can select to have the routine recur on Monday-Friday, can choose the time the routine starts and when the routine ends, can opt to have a sleep sound come on during that time, and can also opt for a night light color to come on at that time. In addition, the parent can choose a facial expression on the clock face 11 and simple animation to reflect the routine (like a sleeping face). In another example, for quiet reading time, the parent can again program similar to the sleep routine. The facial expression/animation on the clock face 11 may include a book icon, for example. If the parent wants the kid to know how much time is left (like a countdown), the parent can set that up as well. With a countdown, the light ring of the illumination feature 13 may gradually change colors to reflect the progress of time. The user may also create a new routine.

After the server 3 receives the setting contents 71, the server 3 may transmit, to the multi-function clock 1, the received setting contents 71 (see 405 in FIG. 4). Then the clock 1 may receive the setting contents 71 (see also 407 in FIG. 4). Based on the setting contents 71, the clock face 11 of the multi-function clock 1 may exhibit the plurality of modes and the first illumination feature 13 and the second illumination feature 15 may operate, as discussed above (see 409 in FIG. 4).

The methods according to the present disclosure may be implemented on a computer as a computer implemented method, or in dedicated hardware, or in a combination of both. Executable code for a method according to the present disclosure may be stored on a computer program product. Examples of computer program products include memory devices, optical storage devices, integrated circuits, servers, online software, etc. Preferably, the computer program product may include non-transitory program code stored on a computer readable medium for performing a method according to the invention when said program product is executed on a computer. In an embodiment, the computer program may include computer program code adapted to perform all the steps of a method according to the invention when the computer program is run on a computer. The computer program may be embodied on a computer readable medium.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A multi-function clock comprising:
a clock face configured to exhibit a first mode in association with a first clock function and a second mode in association with a second clock function;
a first illumination feature configured to operate in association with at least the first mode; and
a second illumination feature configured to operate in association with at least the second mode.

2. The multi-function clock of claim 1, wherein each of the first illumination feature and the second illumination feature is configured to operate independent of each other.

3. The multi-function clock of claim 1, wherein each of the clock face, the first illumination feature, and the second illumination feature is configured to operate independent of each other.

4. The multi-function clock of claim 1, wherein the second illumination feature is further configured to operate in association with the first mode, and
wherein when each of the first illumination feature and the second illumination feature operates in association with the first mode, the first illumination feature exhibits a first behavior in association with the first mode and the second illumination feature exhibits a second behavior in association with the first mode.

5. The multi-function clock of claim 1, wherein the first illumination feature is further configured to change an appearance as an indication of time lapse information.

6. The multi-function clock of claim 5, wherein the first illumination feature is further configured to operate as a countdown timer or a count up timer in consecutive first and second routines,
in the first routine, the first illumination feature is further configured to change from a first color to a second color, and
in the second routine, the first illumination feature is further configured to change from the second color to a third color.

7. The multi-function clock of claim 1, wherein the first mode is a sleep trainer mode and the second mode is other than a sleep trainer mode.

8. The multi-function clock of claim 7, wherein the second mode is in association with a timed activity featuring a countdown illumination.

9. The multi-function clock of claim 1, wherein the first illumination feature and second illumination feature have different shapes.

10. The multi-function clock of claim 9, wherein, in a front view, the first illumination feature at least partially surrounds the clock face, and
in the front view, the second illumination feature at least partially surrounds the clock face.

11. The multi-function clock of claim 10, wherein the first illumination feature is in the shape of a ring,
the ring is configured to illuminate partially or completely,
in one of the first and the second modes, the ring counts down time or counts up time, and the ring and the second illumination feature are configured to exhibit independent behaviors.

12. The multi-function clock of claim 10, wherein the first illumination feature is in the shape of a ring,
the ring comprises a plurality of discrete segments that illuminate independently, and
when the ring partially illuminates, one or more of the discrete segments illuminate and remaining of the discrete segments do not illuminate.

13. The multi-function clock of claim 12, wherein the second illumination feature at least partially surrounds the first illumination feature.

14. The multi-function clock of claim 13, wherein the second illumination feature is configured to change appearance over time.

15. The multi-function clock of claim 1, wherein the clock face is configured to exhibit at least one of the time or an image of an activity that is timed.

16. The multi-function clock of claim 1, wherein at least one of an activity of the clock face, an activity of the first illumination feature, and an activity of the second illumination feature is configured to operate in response to the multi-function clock being tapped.

17. The multi-function clock of claim 1, wherein an appearance of the second illumination feature is configured to change based on a preset wake-up time.

18. A method, comprising:
causing a user device to exhibit at least one setting screen for a first mode in association with a first clock function and a second mode in association with a second clock function;
receiving, from the user device, setting contents of the first mode and the second mode;
transmitting, to a multi-function clock, the received setting contents that configure:
a clock face of the multi-function clock to exhibit the first mode and the second mode;
a first illumination feature of the multi-function clock to operate in association with at least the first mode; and
a second illumination feature of the multi-function clock to operate in association with at least the second mode.

19. A server, comprising:
a memory that stores a plurality of instructions;
processor circuitry that couples to the memory and is configured to execute the instructions to:
cause a user device to exhibit at least one setting screen for a first mode in association with a first clock function and a second mode in association with a second clock function;
receive, from the user device, setting contents of the first mode and the second mode;
transmit, to a multi-function clock, the received setting contents that configure:
a clock face of the multi-function clock to exhibit the first mode and the second mode;
a first illumination feature of the multi-function clock to operate in association with at least the first mode; and
a second illumination feature of the multi-function clock to operate in association with at least the second mode.
